(19) United States
(12) Patent Application Publication
(10) Pub. No.: US 2002/0124384 A1
(43) Pub. Date: Sep. 12, 2002

(54) Method for fabricating a permanent magnetic structure in a substrate

(75) Inventors: Svetlana Reznik, Rochester, NY (US); Bryan A. Beaman, Churchville, NY (US); Edward P. Furlani, Lancaster, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/803,851

(22) Filed: Mar. 12, 2001

(51) Int. Cl. H01F 3/08; H01F 27/24; H01F 7/06

(52) U.S. Cl. 29/608; 336/233

(57) ABSTRACT

A method for fabricating a permanent magnetic structure in a substrate, the method comprises the steps of providing a substrate with at least one cavity; providing magnetic particles dispersed with a bonding material for forming a bonding compound; filling the cavities with the bonding compound; and curing the compound to form the permanent magnetic structure in the substrate.

### FIELD OF THE INVENTION

The invention relates generally to the field of magnetization and, more particularly, to substrates having cavities which contain a magnetized compound.

### BACKGROUND OF THE INVENTION

Advances in micro-systems technology have spawned the rapid development of a variety of devices for both research and commercial use. These devices include accelerometers, light modulators, micro-fluidic devices, micro-motors, molecular filters and various actuators and sensors. To date, the majority of MEMS actuators have been electrostatically driven. There are at least two reasons for this. First, electrostatic activation is compatible with standard microelectronic fabrication methods. Secondly, the electrostatic force scales relatively well at the micro-domain. Specifically, if the electric field is kept constant, the electrostatic force scales as L², where L is the characteristic dimension of the device. Thus, if the size of the device is decreased by ten, the electrostatic force decreases by a factor of one hundred.

The implementation of magnetically actuated MEMS devices is much less developed then the electrostatic case. One reason for this is that the magnetic force for current driven devices scales as L⁴ when the current density is kept constant. This is two orders of magnitude weaker than the electrostatic case. This disadvantage can be overcome if permanent magnets are used. Specifically, if all the linear dimensions of a permanent magnet are reduced, the field strength at all the re-scaled observation points remains constant (assuming that the magnetization is constant). Moreover, there is no power consumption. However, few if any methods exist for producing integrated permanent magnet structures for use in MEMS devices.

Therefore, a need exists for a practical method for fabricating permanent magnet structures on the order of 10 to 100s of microns on a substrate for use as a field source in a MEMS device. More specifically, there exists a need for such a method that can be adapted for the batch processing in which tens to hundreds of devices can be simultaneous fabricated on a single silicon wafer.

### SUMMARY OF THE INVENTION

A method for fabricating a permanent magnetic structure in a substrate, the method comprises the steps of: (a) providing a substrate with at least one cavity; (b) providing magnetic particles dispersed with a bonding material for forming a bonding compound; (d) filling the cavities with the bonding compound; and (e) curing the compound to form the permanent magnetic structure in the substrate.

### BRIEF DESCRIPTION OF THE DRAWINGS

The above and objects, features and advantages of the present invention will become apparent when taken in conjunction with the following description and drawings wherein identical reference numerals have been used, where possible, to designate identical features that are common to the figures, and wherein:

FIG. 1 is a perspective of a substrate with micromachined recesses;

FIG. 2 is a view of a magnetic particle that is to be embedded in a the recesses in the substrate;

FIG. 3 is a view of a collection of magnetic particles filled in a recess in a substrate;

FIG. 4 shows an apparatus for producing ultrasound energy for application to the substrate with the deposited magnetic particles; and

FIG. 5 shows a process for magnetizing the magnetic particles once they are embedded.

### DETAILED DESCRIPTION OF THE INVENTION

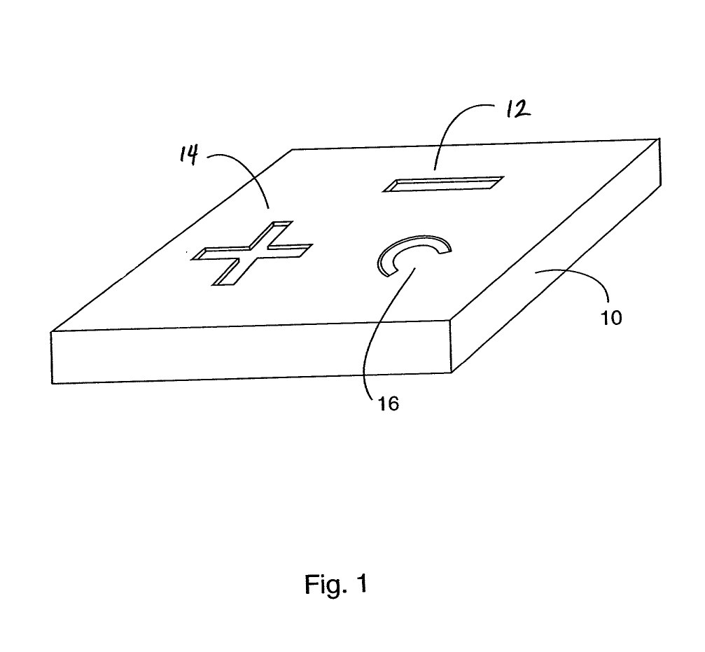

Referring to FIG. 1, there is shown a perspective view of a silicon substrate 10 having a plurality of recesses 12, 14, 16 that may range from 10 to 100′ of microns. The recess may have a variety of shapes, for example a cross-shape 14, arcuate 16, linear 12 and the like.

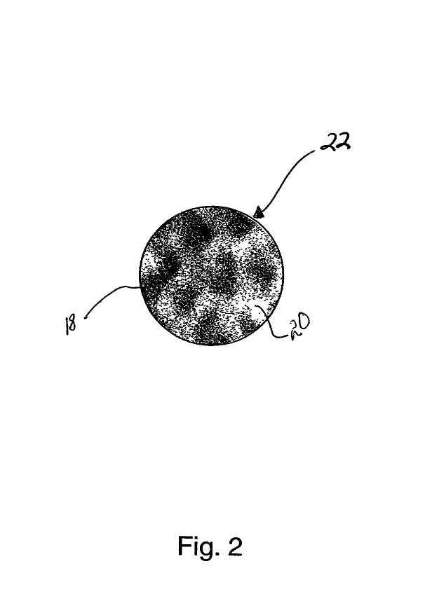

Referring to FIG. 2, there is shown a view of a magnetic particle 18 for filling the cavities, as described in detail hereinbelow. The magnetic particle 18 is preferable ferric oxide (Fe₂O₃), and the particle size is preferably from 1 to 5 microns. The magnetic particle 18, preferably Hc of 315 Oe (approximately 40% ferrite) doped with Co is mixed with bonding compound for forming a magnetizable-bonding magnetic compound 22 that adheres to the cavities 12, 14, 16 of the substrate 10 when placed therein.

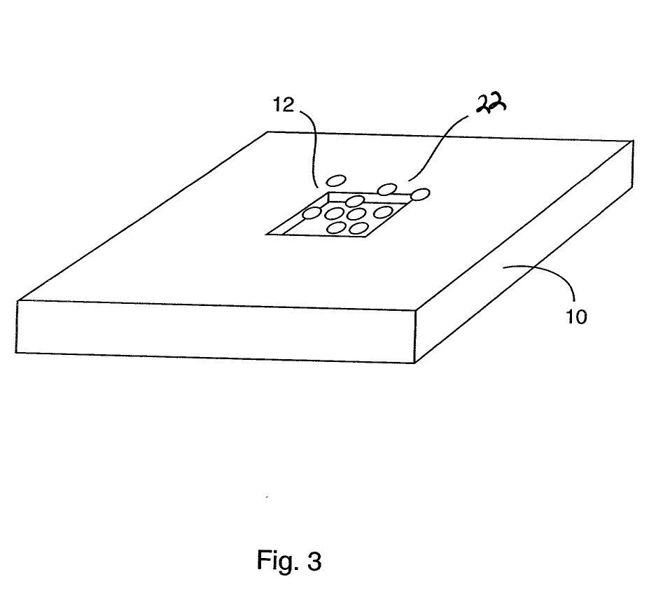

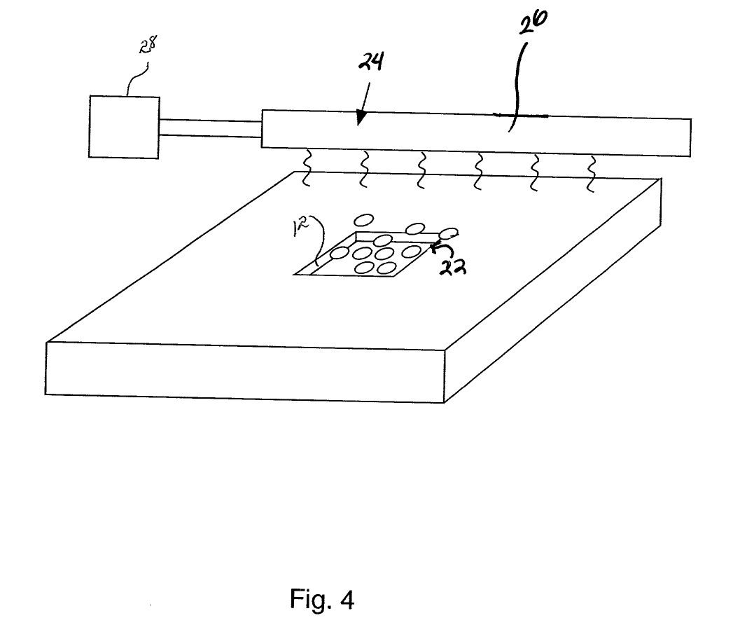

In this regard and referring to FIG. 3, there is shown the magnetizable-bonding compound 22 placed in the cavity 12 of the silicon wafer 10. For clarity of illustration, only one of the cavities is shown although there are a plurality of cavities. Referring to FIG. 4, there is shown an ultrasound apparatus 24 having a transducer 26 and a power supply 28 which, when energized, causes the transducer 26 to apply ultrasound energy to the substrate 10 having the deposited compound 22. This causes the compound 22 to be compactly placed in the cavity 12. After the compound 22 are packaged into the cavity 12, the compound is fused in the wafer cavities preferably at 200 degrees C. for 0.5 to 1 seconds depending on the size of the cavity.

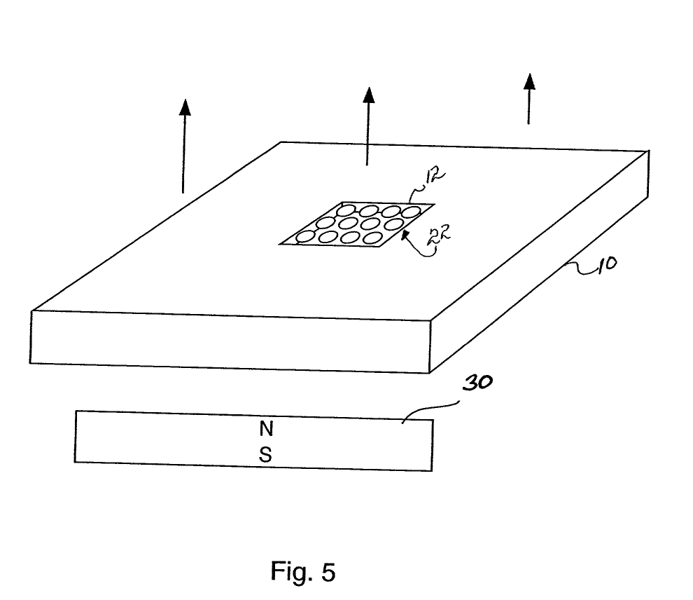

Referring to FIG. 5, there is shown the magnetizing process of the imbedded compound 22. A permanent magnet 30 is used to polarize the particles 18 of the compound 22 in a predetermined preferred orientation. Alternatively, magnetic heads or electromagnetic coils could used be also. The magnetic field could be applied before or after the fusing of the compound 22.

Therefore, the invention has been described with reference to a preferred embodiment. However, it will be appreciated that variations and modification can be effected by a person of ordinary skill in the art without departing from the scope of the invention.

What is claimed is:

1. A method for fabricating a permanent magnetic structure in a substrate, the method comprising the steps of
(a) providing a substrate with at least one cavity;
(b) providing magnetic particles dispersed with a bonding material for forming a bonding compound;
(c) filling the cavities with the bonding compound; and
(d) curing the compound to form the permanent magnetic structure in the substrate.

2. The method as in claim 1 further comprising the step of magnetizing the cured compound.

3. The method as in claim 1, wherein step (b) includes providing bonded magnetic particles with Hc of 315 Oe doped with Co.

4. The method as in claim 1, wherein step (c) includes curing the compound at substantially 200 degrees C.

5. The method as in claim 4, wherein step (c) includes curing the compound at substantially 0.5 to 1 second.

6. The method as in claim 1, wherein step (a) includes providing either an arcuate-shaped cavity, an cross-shaped cavity, or a linear-shaped cavity.

7. The method as in claim 6 further comprising providing a plurality of cavities each of which may be arcuate-shaped, cross-shaped, or linear-shaped.

8. A magnetized substrate comprising:
(a) a substrate with at least one cavity; and
(b) magnetic particles dispersed with a bonding material for forming a bonding compound which compound is placed in the cavity and is magnetized.

9. The substrate as in claim 8, wherein the cavity includes a shape which is either linear, arcuate or cross.

10. The substrate as in claim 9, wherein the bonded magnetic material has coercivity Hc of 315 Oe doped with Co.
